(19) United States
(12) Patent Application Publication
(10) Pub. No.: US 2013/0005896 A1
(43) Pub. Date: Jan. 3, 2013

(54) Expandable Graphite Particles and Methods of Making Same

(76) Inventors: Mukesh Jain, Newark, DE (US); Dattatreya Panse, University, PA (US)

(21) Appl. No.: 13/171,943

(22) Filed: Jun. 29, 2011

(51) Int. Cl. C08K 7/24; C08L 83/04; C08L 63/00; B32B 5/16; C08L 67/00; C08L 77/00; C01B 31/04; C08L 75/04; C08L 23/02

(52) U.S. Cl. 524/496; 423/448; 428/402

(57) ABSTRACT

Small particle size expandable graphite materials are described which are highly expandable, as well as methods of making such unique graphite materials. In one embodiment, expandable graphite particles are described having a particle size nominally between about 100 and 200 US mesh, a chromium content of less than 5 parts per million (ppm) and an expansion of about 80 cc/g or greater when heated at about 500° C.

### FIELD OF THE INVENTION

The present invention relates to expandable graphite particles.

### BACKGROUND

Expandable graphite is a graphite intercalation compound. It is prepared from natural graphite flakes, or particles, using acid intercalation in the presence of an oxidizing agent (for the purposes of this invention, the terms “particle” and “flake” may be used interchangeably). Typical acids used in intercalation include sulfuric acid, nitric acid and acetic acid. Sulfuric acid is the most commonly used acid intercalant. Typical oxidizing agents include sodium dichromate (Na₂Cr₂O₇), potassium permanganate (KMnO₄) and hydrogen peroxide (H₂O₂). Expandable graphite prepared using such acid intercalation processes can expand many times its original volume when heated to high temperatures. The expansion volume typically increases with heating temperature. For example, expansion volume achieved at 1000° C. can be almost double the expansion volume achieved at 500° C. The flake size of the expandable graphite also influences expansion volume, with larger flakes (e.g., bigger than 50 US mesh) showing much higher expansion than smaller expandable graphite flakes (e.g., smaller than 100 US mesh).

In recent years, expandable graphite has found applications as a flame retardant in various end products, such as by incorporating the expandable graphite in polyurethane foams. To be effective in flame retardant applications, expandable graphite which attains a certain desired expansion volume by 500° C. is desired. Small particle size of the expandable graphite combined with high expansion volume at 500° C. is preferred in many flame retardant applications for improved processing and for better mechanical properties of the end product. This combination of expandable graphite characteristics is not easy to achieve, and currently only chromic acid (sodium dichromate) as oxidant and sulfuric acid as intercalant can produce expandable graphite exhibiting high expansion at 500° C. with particle size smaller than 100 US mesh. For environmental reasons, the presence of high amounts of chromium in expandable graphite is undesirable. Existing KMnO₄ oxidant systems do not provide the desired high expansion in combination with small particle size (smaller than 100 US mesh).

### SUMMARY OF THE INVENTION

The present invention is directed to unique small particle size expandable graphite materials which are highly expandable, and to methods of making these unique graphite materials from high bulk density graphite particles and KMnO₄.

The present invention comprises expandable graphite particles having a particle size nominally between about 100 and 200 US mesh, a chromium content of less than 5 parts per million (ppm) and an expansion of about 80 cc/g or greater when heated at about 500° C. As used herein, 100 US mesh means a screen with openings measuring 150 micron and 200 US mesh means a screen with openings measuring 75 micron, in accordance with United States standard sieve mesh measurement. Particles nominally between 100 and 200 US mesh have at least about 80% of the particles in this range, and correspondingly up to about 20% of the particles of larger or smaller size. In an alternate embodiment, the present invention is directed to articles incorporating such unique expandable graphite particles.

As noted above, expandable graphite particles of the invention have an expansion of about 80 cc/g or greater when heated to about 500° C. In a further alternate embodiment, the invention comprises expandable graphite particles have an expansion of about 100 cc/g or greater when heated at about 500° C. In a further alternate embodiment, the expandable graphite particles have an expansion of about 120 cc/g or greater when heated at about 500° C. In one embodiment, the bulk density of the expandable graphite is 0.45 g/cc or greater.

Expandable graphite particle of the present invention typically have a chromium content of less than about 100 ppm. In an alternative embodiment, the particles have a chromium content of less than 50 ppm. In a further alternative embodiment, the particles of the invention may have a chromium content of less than 25 ppm, and in a further embodiment even less than 5 ppm. In some embodiments, the particles may also contain manganese. In an alternative embodiment, the expandable graphite particles may have a manganese content of at least 50 ppm.

In a further embodiment of the invention, the expandable graphite particles may be mixed with polymer resin. Suitable polymer resins may include, but are not limited to, at least one polymer resin selected from the group consisting of polyurethanes, silicones, epoxies, polyolefins, polyesters and polyamides. One non-limiting example of a suitable polyurethane is a crosslinkable polyurethane such as MOR-MELT™ R7001E (from Dow). One non-limiting example of a silicone polymer is ELASTOSIL® LR 7665 (Wacker Silicones).

In a further embodiment, the present invention is directed to a method of making expandable graphite particles comprising providing a natural flake graphite having a nominal size between 100 and 200 (100×200) US mesh and intercalating it with acid in the presence of an oxidizing agent. Preferred acid and oxidizing agents are sulfuric acid and potassium permanganate. Once the intercalation reaction is complete, excess potassium permanganate is neutralized with hydrogen peroxide, and excess acid is washed with water using multiple washings and final neutralization with dilute sodium hydroxide solution. The intercalated graphite prepared according to this procedure is also referred to herein as expandable graphite for the purposes of this invention.

### Test Methods

### Apparent or Bulk Density Test

Apparent, or bulk, density of material was measured according to the general teachings of ASTM B329-06 “Standard Test Method for Apparent Density of Metal Powders and Compounds using the Scott Volumeter.” Specifically, a 50 cc cup was first pre-weighed, then the powder being tested was poured into the cup and allowed to run into the cup until the powder overflowed the top of the cup. A spatula blade was passed over the top of the 50 cc cup to remove excess powder and level the powder with the top of the cup. The cup filled with the powder was weighed, and apparent or bulk density in g/cc was calculated as

$$Bulk density = \frac{( Wt of cup with powder - Wt of empty cup )}{50}$$

### Measurement of Particle Dimensions

The dimensions of the particles were reported based on the US mesh size of a given screen. For example, 100 US mesh and 200 US mesh screens are used having about 150 um and about 75 micron openings, respectively. Referring to a “100×200” mesh fraction refers to a particle size range of 75-150 um. The measurement was performed using a method similar to that described in ASTM D1921-06 “Standard test methods for particle size (Sieve Analysis) of Plastic Materials. A lab electric vibration sieving machine—Type 8411 from Xingfeng Instrument Plant, Shangyu City, China having a rotation rate of 1400 rpm and 200 mm diameter screens was used. The sieving machine was fitted with a 100 US mesh screen oriented above a 200 US mesh screen and a collection pan underneath to collect particles which passed though the 200 mesh screen. About 100 g of powder was weighed using a balance having accuracy of 0.1 g and poured onto a 100 US mesh. A cover was placed on top of the 100 US mesh screen and the machine was run for 10 minutes. The fraction remaining on the 100 US mesh machine was rejected and the fraction collected on the 200 US mesh machine was considered the 100×200 US mesh fraction sample.

### Extraction Method and Analysis

The total chromium and manganese content in bulk samples of expandable graphite was analyzed as per OSHA Method Control Number T-ID125G-FV-03-0209-M (Revision date September, 2002). One gram of the bulk sample was contacted with nitric acid, sulfuric acid and hydrogen peroxide and total chromium and manganese content was analyzed by inductively coupled plasma analysis (ICP), the standard protocol used by Galson Laboratories, East Syracuse, N.Y. Using this procedure, the detection limit for chromium was ≦5 ppm, and the detection limit for the manganese was ≦2.5 ppm.

### Measurement of Amount of Expansion

Expansion of the graphite material was measured in the following manner. One gram of expandable graphite material was added to a graduated quartz beaker. The beaker was placed inside a furnace that had been heated to 500° C. After 2 minutes, the beaker was removed from the furnace, and the volume of the expanded graphite was measured. The amount of expansion was calculated as the final volume and expressed in units of cc/g. The reported values represent the average of two measurements.

### EXAMPLES

Table of Examples

| | Natural Graphite Flakes | | | | | | | Expandable Graphite | | |
|---|---|---|---|---|---|---|---|---|---|---|
| | | Nominal | | | Ratio of | | Ratio of | Nominal | | |
| | | Particle | Bulk | | Acid to | | Oxidant to | Particle | Bulk | Expansion |
| | | Size* | Density | Intercalant | Graphite | Oxidant | Graphite | Size* | Density | Volume |
| | Source | US-Mesh | g/cc | acid | Flakes | Type | Flakes | US-Mesh | g/cc | at 500 C, cc/g |
| Ex 1 | Timcal, | 100 × 200 | 0.62 | H2SO4 (70%) | 3 | KMnO4 | 0.12 | 100 × 200 | 0.48 | 110 |
| | Canada | | | | | | | | | |
| Ex 2 | Timcal, | 100 × 200 | 0.62 | H2SO4 (70%) | 3 | KMnO4 | 0.10 | 100 × 200 | 0.54 | 80 |
| | Canada | | | | | | | | | |
| Ex 3 | Timcal, | 100 × 200 | 0.62 | H2SO4 (70%) | 3 | KMnO4 | 0.14 | 100 × 200 | 0.49 | 120 |
| | Canada | | | | | | | | | |
| Ex 4 | Eagle | 100 × 200 | 0.48 | H2SO4 (70%) | 3 | KMnO4 | 0.12 | 100 × 200 | 0.46 | 105 |
| | Graphite, | | | | | | | | | |
| | Canada | | | | | | | | | |
| Ex 5 | Nacional de | 100 × 200 | 0.52 | H2SO4 (70%) | 3 | KMnO4 | 0.12 | 100 × 200 | 0.49 | 120 |
| | Grafite Ltda | | | | | | | | | |
| Comp 1 | Inner | 100 × 200 | 0.42 | H2SO4 (70%) | 3 | KMnO4 | 0.12 | 100 × 200 | 0.39 | 55 |
| | Mongolia, | | | | | | | | | |
| | China | | | | | | | | | |
| Comp 2 | Inner | 100 × 200 | 0.42 | H2SO4 (75%) | 3 | Na2Cr2O7 | 0.10 | 100 × 200 | 0.37 | 100 |
| | Mongolia, | | | | | | | | | |
| | China | | | | | | | | | |

*At least about 80% of the particle are in this range

### Example 1

Natural flake graphite was obtained (80×150 US mesh, Timcal Graphite & Carbon, Terrebonne, Quebec, CA). The graphite was sieved with 100 and 200 US mesh screens using Kroosh SXE 950 by Minox/Elcan, Mamaroneck, N.Y. The resulting nominal dimension of the flakes was 75-150 micron. The bulk density was measured to be 0.62 g/cc.

About 100 g of the graphite flakes were intercalated using 70% sulfuric acid (H₂SO₄) as the intercalant and potassium permanganate (KMnO₄) as the oxidant. The amount of intercalant was 300 g (3 times the amount of graphite) and the amount of oxidant was 12 g (0.12 times the graphite). The mixture was stirred for 50 minutes at 30 deg C. It was then diluted with 700 ml water, and 12 ml of 27.5% H₂O₂ was added to neutralize excess KMnO₄. The mixture was then stirred for 10 minutes then the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, stirring for 10 minutes and filtering. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven.

The dry intercalated graphite was determined to have a nominal particle size of 100×200 US mesh and a bulk density of 0.48 cc/g. The amount of expansion at 500° C. was measured and determined to be 110 cc/g. Total chromium and manganese content were measured by Galson Laboratories, East Syracuse, N.Y. according to extraction method and analysis described in test methods section. The values for chromium and manganese were <5 ppm and 260 ppm respectively.

### Example 2

Natural flake graphite was obtained (80×150 US mesh, Timcal Graphite & Carbon, Terrebonne, Quebec, CA). The graphite was sieved with 100 and 200 US mesh screens using Kroosh SXE 950 by Minox/Elcan, Mamaroneck, N.Y. The resulting nominal dimension of the flakes was 75-150 micron. The bulk density was measured to be 0.62 g/cc.

About 100 g of the graphite flakes were intercalated using 70% sulfuric acid (H₂SO₄) as the intercalant and potassium permanganate (KMnO₄) as the oxidant. The amount of intercalant was 300 g (3 times the amount of graphite) and the amount of oxidant was 10 g (0.10 times the graphite). The mixture was stirred for 50 minutes at 30° C. It was then diluted with 700 ml water and 10 ml of 27.5% H₂O₂ was added to neutralize excess KMnO₄. After stirring for 10 minutes, the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, stirring for 10 minutes and filtering. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven.

The dry intercalated graphite was measured to have a nominal particle size of 100×200 US mesh and a bulk density of 0.54 cc/g. The amount of expansion at 500° C. was measured to be 80 cc/g. Total chromium and manganese content were <5 ppm and 110 ppm respectively.

### Example 3

Natural flake graphite was obtained (80×150 US mesh, Timcal Graphite & Carbon, Terrebonne, Quebec, CA). The graphite was sieved with 100 and 200 US mesh screens using Kroosh SXE 950 by Minox/Elcan, Mamaroneck, N.Y. The resulting nominal dimension of the flakes was 75-150 micron. The bulk density was measured to be 0.62 g/cc.

About 100 g of the graphite flakes were intercalated using 70% sulfuric acid (H₂SO₄) as the intercalant and potassium permanganate (KMnO₄) as the oxidant. The amount of intercalant was 300 g (3 times the amount of graphite) and the amount of oxidant was 14 g (0.14 times the graphite). The mixture was stirred for 50 minutes at 30° C. It was then diluted with 700 ml water and 14 ml of 27.5% H₂O₂ was added to neutralize excess KMnO₄. After stirring for 10 minutes, the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, stirring for 10 minutes and filtered. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven.

The dry intercalated graphite was measured to have a nominal particle size of 100×200 US mesh and a bulk density of 0.49 cc/g. The amount of expansion at 500° C. was measured to be 120 cc/g. Total chromium and manganese content were <5 ppm and 500 ppm respectively.

### Example 4

Natural flake graphite was obtained (80×150 US mesh, Eagle Graphite Corporation, Courtenay, British Columbia, Canada). The graphite was sieved with 100 and 200 US mesh screens as defined in the Measurement of Particle Dimensions Test Method. The resulting nominal dimension of the flakes was 75-150 micron. The bulk density was measured to be 0.48 g/cc.

About 100 g of the graphite flakes were intercalated using 70% sulfuric acid (H₂SO₄) as the intercalant and potassium permanganate (KMnO₄) as the oxidant. The amount of intercalant was 300 g (3 times the amount of graphite) and the amount of oxidant was 12 g (0.12 times the graphite). The mixture was stirred for 50 minutes at 30° C. It was then diluted with 700 ml water and 12 ml of 27.5% H₂O₂ was added to neutralize excess KMnO₄. After stirring for 10 minutes, the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, stirring for 10 min and filtering. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven. The dry intercalated graphite was measured to have a nominal particle size of 100×200 US mesh and a bulk density of 0.46 cc/g. The amount of expansion at 500° C. was measured to be 105 cc/g. Total chromium and manganese content were <5 ppm and 270 ppm respectively,

### Example 5

Natural flake graphite was obtained (Grafine 97100 Grade from Nacional de Grafite Ltda, Sao Paulo, Brazil). The graphite was sieved with 100 and 200 US mesh screens using a vibratory type sieving equipment from Xinxiang Vibration Sift Machinery Factory in China. The resulting nominal dimension of the flakes was 75-150 micron. The bulk density was measured to be 0.52 g/cc.

About 100 g of the graphite flakes were intercalated using 70% sulfuric acid (H₂SO₄) as the intercalant and potassium permanganate (KMnO₄) as the oxidant. The amount of intercalant was 300 g (3 times the amount of graphite) and the amount of oxidant was 12 g (0.12 times the graphite). The mixture was stirred for 50 minutes at 30° C. It was then diluted with 700 ml water and 12 ml of 27.5% H₂O₂ was added to neutralize excess KMnO₄. After stirring for 10 minutes, the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, stirring for 10 min and filtering. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven. The dry intercalated graphite was measured to have a nominal particle size of 100×200 US mesh and a bulk density of 0.49 cc/g. The amount of expansion at 500° C. was measured to be 120 cc/g. Total chromium and manganese content were <5 ppm and 230 ppm respectively.

### Comparative Example A

Natural flake graphite was obtained (M−192 Grade from Xinhe Xinyi Graphite Co., Ltd, Xinghe town, Inner Mongolia, China). The graphite was sieved with 100 and 200 US mesh screens using a vibratory type sieving equipment from Xinxiang Vibration Sift Machinery Factory in China. The resulting nominal dimension of the flakes was 75-150 micron. The bulk density was measured to be 0.42 g/cc.

About 100 g of the graphite flakes were intercalated using 70% sulfuric acid (H₂SO₄) as the intercalant and potassium permanganate (KMnO₄) as the oxidant. The amount of intercalant was 300 g (3 times the amount of graphite) and the amount of oxidant was 12 g (0.12 times the graphite). The mixture was stirred for 50 minutes at 30° C. It was then diluted with 700 ml water and 12 ml of 27.5% H₂O₂ was added to neutralize excess KMnO₄. After stirring for 10 minutes, the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, stirring for 10 minutes and filtering. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven.

The dry intercalated graphite had a nominal particle size of 100×200 US mesh and a bulk density of 0.39 cc/g. The amount of expansion at 500° C. was measured to be 55 cc/g. Total chromium and manganese content were <5 ppm and 120 ppm respectively.

### Comparative Example B

Natural flake graphite was obtained (M−192 Grade from Xinhe Xinyi Graphite Co., Ltd, Xinghe town, Inner Mongolia, China). The graphite was sieved with 100 and 200 US mesh screens as defined in the Measurement of Particle Dimensions Test Method. The resulting nominal dimension of the flakes was 75-150 micron. The bulk density was measured to be 0.42 g/cc.

About 100 g of the graphite flakes were intercalated using 75% sulfuric acid (H₂SO₄) as the intercalant and sodium dichromate (Na₂Cr₂O₇) as the oxidant. The amount of intercalant was 300 g (3 times the amount of graphite) and the amount of oxidant was 10 g (0.10 times the graphite). The mixture was stirred for 50 minutes at 30° C. It was then diluted with 700 ml water. After stirring for 10 minutes, the mixture was filtered using a Buckner funnel and vacuum. The resulting cake was washed 9 additional times using 700 ml water each time and then dried for 1 hour at 100° C. in an air circulated oven. The dried flakes were washed 3 more times by dispersing in 700 ml of water, then stirring for 10 minutes and filtering. The filtered cake was dispersed in 200 ml of water, and 6.7 ml sodium hydroxide (30% aqueous solution) was added and stirred for 20 minutes. The mixture was filtered and dried for 1 hour at 100° C. in an air circulated oven. The dry intercalated graphite was measured to have a nominal particle size of 100×200 US mesh and a bulk density of 0.40 cc/g. The amount of expansion at 500° C. was measured to be 100 cc/g. Total chromium content was 230 ppm.

We claim:

1. An article comprising expandable graphite particles, said expandable graphite particles having:
a nominal particle size between about 100 and 200 US mesh;
a chromium content of less than about 100 ppm; and
an expansion of about 80 cc/g or greater when heated at about 500° C.

2. The article of claim 1, wherein said expandable graphite particles have an expansion of about 100 cc/g or greater when heated at about 500° C.

3. The article of claim 1, wherein said expandable graphite particles have an expansion of about 120 cc/g or greater when heated at about 500° C.

4. The article of claim 1, where in the bulk density of the expandable graphite is 0.45 g/cc or greater.

5. The article of claim 1, wherein said chromium content is less than 50 ppm.

6. The article of claim 1, wherein said chromium content is less than 25 ppm.

7. The article of claim 1, wherein said chromium content is less than 5 ppm.

8. An article comprising expandable graphite particles said expandable graphite particles having:
a nominal particle size between about 100 and 200 US mesh;
a manganese content of at least 50 ppm;
a chromium content of less than 100 ppm; and
an expansion of about 80 cc/g or greater when heated at about 500° C.

9. The article of claim 8, wherein said expandable graphite particles have an expansion of about 100 cc/g or greater when heated at about 500° C.

10. The article of claim 8, wherein said expandable graphite particles have an expansion of about 120 cc/g or greater when heated at about 500° C.

11. The article of claim 8, where in the bulk density of the expandable graphite is 0.45 g/cc or greater.

12. The article of claim 8, wherein said chromium content is less than 50 ppm.

13. The article of claim 8, wherein said chromium content is less than 25 ppm.

14. The article of claim 8, wherein said chromium content is less than 5 ppm.

15. An article comprising a mixture of polymer resin and expandable graphite particles, said expandable graphite particles having:
a nominal particle size between about 100 and 200 US mesh;
a chromium content of less than 100 ppm; and
an expansion of about 80 cc/g or greater when heated at about 500° C.

16. The article of claim 15, wherein said chromium content is less than 50 ppm.

17. The article of claim 15, wherein said chromium content is less than 25 ppm.

18. The article of claim 15, wherein said chromium content is less than 5 ppm.

19. The article of claim 15, where in the bulk density of the expandable graphite is 0.45 g/cc or greater.

20. The article of claim 15, wherein said polymer resin is selected from the group consisting of polyurethanes, silicones, epoxies, polyolefins, polyesters and polyamides.

21. The article of claim 15, wherein said expandable graphite particles have an expansion of about 100 cc/g or greater when heated at about 500° C.

22. The article of claim 15, wherein said expandable graphite particles have an expansion of about 120 cc/g or greater when heated at about 500° C.

23. A method of making expandable graphite particles, said expandable graphite particles having a bulk density of at least about 0.45 cc/g, a particle size between about 100 and 200 US mesh, a chromium content of less than 100 ppm; and an expansion of about 80 cc/g or greater when heated at about 500° C., said method comprising the sequential steps of:
sieving natural flake graphite to a nominal size between about 100 and 200 US mesh;
intercalating the natural flake graphite with acid in the presence of an oxidizing agent;
washing excess acid with water; and neutralizing the intercalated graphite with dilute sodium hydroxide solution.

24. A method of making expandable graphite particles, said expandable graphite particles having a particle size between about 100 and 200 US mesh, a chromium content of less than 100 ppm; and an expansion of about 80 cc/g or greater when heated at about 500° C., said method comprising the sequential steps of:
sieving natural flake graphite bulk density of at least about 0.48 cc/g, to a nominal size between about 100 and 200 US mesh;
intercalating the natural flake graphite with acid in the presence of an oxidizing agent;
washing excess acid with water; and
neutralizing the intercalated graphite with dilute sodium hydroxide solution.

25. The method of claim 23, wherein said natural flake graphite particles have a bulk density of greater than 0.45 cc/g.

26. The method of claim 24, wherein said expandable graphite particles have a bulk density of about 0.45 g/cc or greater.

27. The method of claim 23, wherein the acid comprises sulfuric acid and the oxidizing agent comprises potassium permanganate.

28. The method of claim 23, wherein said expandable graphite particles have an expansion of about 100 cc/g or greater when heated at about 500° C.

29. The method of claim 23, wherein said expandable graphite particles have an expansion of about 120 cc/g or greater when heated at about 500° C.

30. The method of claim 24, wherein the acid comprises sulfuric acid and the oxidizing agent comprises potassium permanganate.

31. The method of claim 24, wherein said expandable graphite particles have an expansion of about 100 cc/g or greater when heated at about 500° C.

32. The method of claim 24, wherein said expandable graphite particles have an expansion of about 120 cc/g or greater when heated at about 500° C.

33. Expandable graphite particles, said expandable graphite particles having:
a nominal particle size between about 100 and 200 US mesh;
a chromium content of less than 100 ppm; and
an expansion of about 80 cc/g or greater when heated at about 500° C.
